(19) United States
(12) Patent Application Publication
(10) Pub. No.: US 2010/0215878 A1
(43) Pub. Date: Aug. 26, 2010

(54) INK COMPOSITION, OXYGEN AND/OR pH INDICATOR AND PACKAGE

(75) Inventors: Eero Hurme, Espoo (FI); Tiina Tajamäki, Espoo (FI)

Correspondence Address: MERCHANT & GOULD PC, P.O. BOX 2903, MINNEAPOLIS, MN, 55402-0903, US

(73) Assignee: Valtion Teknillinen Tutkimuskeskus, Espoo (FI)

(21) Appl. No.: 12/063,293

(22) PCT Filed: Aug. 9, 2006
(86) PCT No.: PCT/FI06/00274

§ 371 Date: Mar. 24, 2010

(30) Foreign Application Priority Data
Aug. 9, 2005 (FI) 20050809

(51) Int. Cl. B32B 1/02; B05D 1/36; B32B 3/10; C09D 11/10; C09D 11/14

(52) U.S. Cl. 428/35.7; 427/265; 428/201; 428/202; 524/557; 106/31.13; 524/548; 524/388; 524/377

(57) ABSTRACT

The invention concerns an ink composition comprising an oxidizing and reducing agent and/or pH colorant as the dye, polymeric material as the binder, as well as a pH adjuster and volatile solvent. Further, the invention concerns a method for manufacturing an oxygen and/or pH indicator, in which the ink composition is printed and reduced, or reduced using a volatile reducer and printed; an oxygen and/or pH indicator manufactured by the method, as well as a package for stating a leakage, a change caused by oxygen content and/or deterioration of a product.

### FIELD OF THE INVENTION

The invention relates to an ink composition, a method for manufacturing an oxygen and/or pH indicator, an oxygen and/or pH indicator manufactured by the method, and a package for stating a leakage, a change in oxygen content of a package, or deterioration of a product within it.

### BACKGROUND OF THE INVENTION

It is known to use an indicator that changes color to indicate a change in the conditions of a package to detect a leakage, a change in oxygen content of a package or deterioration of a product within it. It is known in prior art to use in packages various indicators that react as a consequence of oxygen entering the package or change in pH, indicating a change in color. For example, publication FI 94802 describes various leak indicators to be used in packages.

Publication U.S. Pat. No. 4,526,752 discloses an oxygen indicator functioning in an anaerobic environment and comprising a substrate carrying, in leuco state, a dye free of reducing agent and reacting irreversibly with oxygen with a change in color. The indicator is manufactured by dissolving the dye in water containing a volatile reducing agent and removing the reducing agent in an environment in which there is no air and sealing the package. The indicator can be placed or printed onto a film that seals the package.

A problem with known indicators is the poor heat resistance of the ink composition, making them poorly suitable for the packages of sterilized products, for example.

### OBJECTIVE OF THE INVENTION

It is an objective of the invention to eliminate the disadvantages mentioned above.

It is an objective of the invention to disclose a new type of oxygen and/or pH indicator and an ink composition having suitable heat resistance for packages of sterilized products. Further, it is an objective of the invention to disclose an oxygen and/or pH indicator and an ink composition that are well suited for products to be stored at cool temperature.

### SUMMARY OF THE INVENTION

The ink composition in accordance with the invention is characterized by what has been presented in claim 1.

The manufacturing method of an oxygen and/or pH indicator and the oxygen and/or pH indicator, according to the invention, are characterized by what has been presented in claims 11 and 16.

The package in accordance with the invention is characterized by what has been presented in claim 21.

The ink composition in accordance with the invention comprises an oxidizing and reducing agent and/or pH colorant as the dye, polymeric material as the binder, as well as a pH adjuster and volatile solvent.

As the dye one can use oxidizing and reducing agents, pH colorants known in the art, and/or mixtures of these. Appropriate for use is any dye that oxidizes and changes color under the influence of oxygen in the air and/or change of pH and has good heat resistance. This kind of dye can be selected, for example, from indigo colors such as indigo and indigo carmine and/or similar.

Preferably, indigo carmine is used as the dye.

The binder binds the components of the ink composition together and attaches the indicator to the surface to be printed. The binder can be selected according to the base to be printed and to suit the printer. As the binder one can use a polymeric material such as polyol, polymer, whose starting material can be, for example, butadiene, styrene, vinyl acetate, acrylic acid, metacrylic acid and/or their esters, polyvinyl pyrrolidone, polyvinyl alcohol, ketone resin, cellulose derivatives such as cellulose ester, cellulose ether or modified cellulose, such as carboxy methyl cellulose and microcrystalline cellulose and/or mixtures thereof.

Preferably, polyvinyl alcohol, ketone resin and cellulose derivative such as carboxy methyl cellulose, microcrystalline cellulose and/or mixtures thereof are used as the binder.

The pH adjuster can be reducing sugar, organic/inorganic acid and/or its salt such as ascorbic acid and citric acid, as well as sodium ascorbate, sodium sulphate, sodium bisulphate, sodium disulphate, sodium pyrophosphate, calcium ascorbate, dithionite, metal powders such as iron and zinc, metal salts such as several iron compounds.

Preferably, the pH adjuster is sodium pyrophosphate.

The solvent to be used in an ink composition in accordance with the invention is intended to make the texture of the ink composition more homogenous and also to exit from the ink composition. As the solvent one can use a volatile solvent such as water, volatile alcohol, ketone, ester and/or any comparable volatile solvent dissolving the components of the ink composition. Preferably, water is used as the solvent.

In the ink composition in accordance with the invention it is also possible to use a moisture adjuster. Moisture adjusters can include polyethylene glycol, glycerol, propylene glycol, sorbitol, erytritol and/or mixtures thereof. Preferably, glycerol, polyethylene glycol and/or propylene glycol is used as the moisture adjuster.

In the ink composition in accordance with the invention it is also possible to use as the redox material a reducing agent which reduces the color and evaporates and/or is made evaporate under printing and/or packaging conditions. The volatile reducing agent can be alcohol, ammonia, thiol, aldehyde, amine with a low molecular weight and/or any reducing agent functioning in a similar way.

Preferably, ammonia is used as the volatile reducing agent.

An ink composition according to the invention can additionally contain additives generally used in ink compositions and indicators, such as an enzyme, plasticizing agent, wax, oxygen absorbent and/or commercial lacquers. The enzyme can be laccase, glucose oxidase and peroxidase. When necessary, the ink composition and indicator can also contain a substrate and/or oxygen absorbent. When using mainly enzymes, appropriate substrates include substrates typical of each enzyme. Possible oxygen absorbents are described, for example, in patent FI 94802.

The oxygen and/or pH indicator is manufactured by mixing an oxidizing and reducing agent and/or pH colorant, polymeric material and pH adjuster with a volatile solvent. The ink composition is prepared by using conventional colorant preparation/mixing techniques. Thereafter, the mixture is printed on a substrate and the ink composition is reduced, or alternatively prior to printing, a volatile reducing agent is added to the mixture that reduces the dye, and the color mixture is printed on a substrate. When desired, it is also possible to add to the ink composition a moisture adjuster and other additives at the mixing step prior to the printing.

Preferably, the manufacture of the indicator is performed under oxygen-free conditions, such as in a vacuum, in a nitrogen and/or argon atmosphere. The ink composition can be printed using any known printing technique such as aniline printing, gravure printing, offset or inkjet printing.

An ink composition printed on a substrate is first reduced using e.g. treatment with heat and/or a volatile reducing agent. The treatment with heat is performed at an elevated temperature such as at a sterilization temperature, usually at a temperature of 100-165° C., more preferably at a temperature of 120-130° C. Reduction performed using treatment with heat is well suited for products and packages to be sterilized. In the reduction one can use volatile reducing agents listed above. A volatile reducing agent is preferably a volatile alkaline agent such as ammonia. The reduction can be performed e.g. at alkaline gas or with an alkaline reducing agent that is contacted with the ink composition just before packaging.

In one embodiment, the indicator is stored at alkaline gas such as gaseous ammonia, the indicator remaining in a reduced state for the duration of storage.

In another embodiment, the alkaline reducing agent has been placed on a removable foil disposed on top of the indicator, the alkaline reducing agent reducing the ink composition in conjunction with the removal of foil just before packaging.

In an alternative method, the reducing agent to be used alternatively and the solvent are usually removed by evaporation. The package can be sealed in conjunction with the printing process, that is, when attaching the indicator, so that the sealed package remains oxygen-free. The indicator is manufactured and printed on the packaging material preferably by the inkjet technique.

Further, when necessary, the indicator can be activated by subjecting it to conditions triggering its activation, such as moisture, heat, light and/or an activating agent.

In one embodiment, a volatile alkaline agent is added to the ink composition; the mixture is printed on a substrate, which is an adhesive label, and the indicator thus manufactured is stored in a dry place protected from humidity. An indicator label activates due to moisture when it is attached by a packaging machine to a product package such as a convenience food package whose product contains moisture.

The ink composition can be printed directly onto a substrate forming the packaging material. In that case, the ink composition is printed directly onto the package at the moment of packaging.

The ink composition can also be printed onto a substrate forming a separate base that is attached to the package at the moment of packaging. The material of the separate base is preferably the same as that of the packaging material. The separate base is preferably in the form of an adhesive label that is easy to attach to the package in conjunction with packaging.

The ink composition can also be printed onto the substrate in two phases. First, an ink composition is printed onto the substrate. On top of a sufficiently dry first layer it is possible to print an overlay consisting of a binder and solvent at the least. An overlay enables one to regulate the reaction rate of the indicator.

The substrate and packaging material to be used may be pulp-, plastic and/or glass-based and/or any other generally used packaging material. Pulp-based material can include surface-treated or untreated paper, cardboard, dissolving pulp-based film material or other cellulose-based material. The plastic material can include polyethylene, polyproylene, other polyolefin, polyester, polystyrene, polyamide, or any other plastic material generally used as packaging material. Further, the substrate and packaging material can consist of a laminate of the aforesaid or other known packaging materials, or of some other kind of composite material. The material can also be coated.

It is possible to attach to the indicator a film containing an alkaline reducing agent that reduces the ink composition in conjunction with removal. It is also possible to attach to the indicator a film protecting from oxygen that has been made of a material only slightly permeable or impermeable to an oxidizing agent, these including PET, PP, EVOH, PVDC or regenerate cellulose.

The indicator is attached to the package prior to sealing it and is reactive immediately after packaging the product. An indicator attached to a package reacts to oxygen entering the package from outside thereby indicating ageing of the package by change of color. In addition, the indicator reacts to oxygen that has gotten into the package through breakage of the package, indicating a leakage. The indicator also reacts to the change of pH caused by deterioration of a product.

Besides the inner surface of a package, a separate indicator can be placed within the seam area of a package so that it is not in contact with the gas space of the package. In that case, the indicator does not necessarily activate due to leakage of the package but only after opening the cover film of the package.

Change of color of an indicator can be detected in the wavelength area of visible light 400 to 780 nm or in the wavelength area of UV radiation 100 to 400 nm. Without doing damage to the package, the change of color of an indicator can be read visually or automatically using optic and other reading techniques.

Preferably, the package can be used for packages of foodstuffs, pharmaceuticals or cosmetics products.

When using the indicator in conjunction with a bar identifier of a package, the oxygen that has entered it through ageing and/or deterioration of the package, and/or the change of pH caused by deterioration of a product causes a change in color, which finally inactivates the identifier, that is, makes it impossible to read and/or identify the identifier. This prevents, for example, a shop from selling an out-of-date and/or broken package.

The invention enables manufacture of a dependable, irreversible indicator that is functional right after packaging and withstands high temperatures used for products to be sterilized. Further, an advantage of the indicator in accordance with the invention is its suitability also for products to be stored at cool temperature. In addition, the ink composition/indicator in accordance with the invention can be printed directly onto a package using the dripping technique. Further, the components of the ink composition and indicator in accordance with the invention are inexpensive.

In the following section, the invention will be described in detail with the aid of examples of its embodiments.

### DETAILED DESCRIPTION OF THE INVENTION

### Example 1

The test studied the effect of the components of the indicator composition on the change of color of the indicator at a sterilization temperature (121° C.), as well as the change of color of the indicator due to the effect of oxygen.

The test used four indicator compositions in accordance with the invention A to D, which were printed manually by the Hand Coater bar onto a PET/PP film (the wet thickness of the layer was 100 μm), as well as indicator composition E, which was printed manually by the Hand Coater bar onto filter paper (the wet thickness of the layer was 40 μm). The ink compositions were prepared from the components presented in Table 1 by mixing in bottles separately the color and water, as well as the pH adjuster and water. Finally, the color solution, pH adjuster, binders and in some cases the moisture adjuster were mixed with one another. After sufficient drying of the printed indicator mixture, a coating layer (KRUMBHAAR K1717) was printed manually onto some of the indicators, enabling one to regulate the reaction rate of the indicator.

TABLE 1

| Indicator composition | A | B | C | D | E |
|---|---|---|---|---|---|
| Color: | 0.03 g | 0.03 g | 0.03 g | 0.03 g | 0.03 g |
| Indigo carmine | | | | | |
| pH adjuster: | 0.46 g | 0.46 g | 0.46 g | 0.46 g | 0.46 g |
| Sodium phosphate | | | | | |
| Solvent: | 10 ml | 10 ml | 10 ml | 10 ml | 10 ml |
| Water | | | | | |
| Binder: | | | | | |
| Microcrystalline | 2 g | 2 g | 2 g | | |
| Cellulose | | | | | |
| Sicpa 1100 | 2.5 ml | 2.5 ml | 2.5 ml | | |
| binder | | | | | |
| Polyvinyl alcohol | | | | 0.25 g | 0.25 g |
| Moisture adjuster/ | | 0.5 ml | 0.5 ml | | |
| stabilizer: | | | | | |
| Glycerol | | | | | |
| Coating layer: | 200 g/ | | 200 g/ | | 400 g/ |
| Ketone resin | 1.80 μm | | 1.80 μm | | 1.40 μm |
| (KRUMBHAAR | | | | | |
| K1717) | | | | | |

Pieces of uniform size (2 cm×2 cm) were cut out of the indicator films prepared for examining the functionality of the indicator, and adhesive tape was used to attach the pieces to the inner size of packages (PET/AlOx/PA/sealant) prepared for sterilization. In addition, an oxygen absorbent (Atco HV210) was added to the packages. Prior to seaming, the package was provided with a vacuum, after which the package was filled with protective gas (100% N₂). The packages were autoclaved within a day at 121° C. for 60 minutes. After the autoclaving, the packages were stored for 2 days at a temperature of 20° C. in room light. The packages were opened and the change of color of the indicator was examined visually.

The results are shown in Table 2

TABLE 2

| Indicator | A | B | C | D | E |
|---|---|---|---|---|---|
| Change of | | | Blue → | | |
| color prior to | | | Pale | | |
| sterilization | | | | | |
| Change of | Blue → | Blue → | Pale → | Blue → | Blue → |
| color | Yellow | Green | Yellow | Yellow | yellow |
| during sterilization | | Yellow | | | |
| Change of | Yellow → | Yellow → | Yellow → | Yellow → | Yellow → |
| color | Blue, | Blue, | Blue, | Blue, | Blue, |
| after opening | Irreversible | Irreversible | Irreversible | irreversible | Irreversible |
| of the package | | | | | |
| Color change | 20 | 15 | 20 | 15 | 20 |
| time from | | | | | |
| the opening | | | | | |
| (min.) | | | | | |

### Example 2

The test studied the change of color of an indicator due to the effect of alkaline treatment, as well as the change of color of an indicator due to the effect of oxygen.

The test used indicator composition C in accordance with that shown in Table 1 of Example 1, which composition was printed manually by the Hand Coater bar onto a PP film (the wet thickness of the layer was 100 μm. The ink composition was prepared as shown in Example 1. After sufficient drying of the printed indicator mixture, a coating layer (ketone resin KRUMBHAAR K1717, at isopropyl alcohol 200 g/l, 40 μm) was printed manually onto the indicator.

Pieces of uniform size (2 cm×2 cm) were cut out of the indicator films prepared for examining the functionality of the indicator, and adhesive tape was used to attach the pieces to the inner size of packages (Opalen HB65, size 14.5 cm×17 cm). Also, an oxygen absorbent (Ageless SS50) and a wad of cotton were added to the packages, and the wad of cotton was wetted with 500 μl of a 5% ammonium hydroxide solution. Prior to seaming, the package was provided with a vacuum, after which the package was filled with protective gas (N₂ 100%). After 90 minutes the packages were opened and the indicators that had turned yellow were packaged into new packages (Dyno 567 PE-HD, 150 ml, a cover material allowing easy seaming) as quickly as possible (in about a minute). Part of the packages was provided with an oxygen remover (Ageless SS50). Prior to seaming, the package was provided with a vacuum, after which the package was filled with protective gas (either N₂, 100% or CO₂/N₂ 80%/20%). The packages were stored at a temperature of 20° C. in room light. After storage of 2 days, the packages were opened and the change of color of the indicators was examined visually.

The results are shown in Table 3

TABLE 3

| Indicator | F | G | H | J |
|---|---|---|---|---|
| Protective gas | N₂ 100% | N₂ 100% | CO₂/N₂ | CO₂/N₂ |
| | | | 80%/20% | 80%/20% |
| Oxygen remover | Yes | No | Yes | No |
| Change of | Yellow → | Yellow → | Yellow → | Yellow → |
| color after | Blue, irreversible | Blue, irreversible | Blue, | Blue, irreversible |
| opening of the | | | irreversible | |
| package | | | | |
| Color change | 20 | 20 | 20 | 20 |
| time from the | | | | |
| opening | | | | |
| (min.) | | | | |

The invention is not limited merely to the embodiment examples referred to above; instead many variations are possible within the scope of the inventive idea defined by the claims.

1. An ink composition comprising an oxidizing and reducing agent and/or pH colorant as the dye, polymeric material as the binder, as well as a pH adjuster and volatile solvent.

2. The ink composition in accordance with claim 1, wherein the ink composition comprises a moisture adjuster.

3. The ink composition in accordance with claim 1, wherein the ink composition comprises a volatile reducing agent as the redox material.

4. The ink composition in accordance with claim 1, wherein the dye is an indigo color.

5. The ink composition in accordance with claim 3, wherein the dye is indigo carmine.

6. The ink composition in accordance with claim 1, wherein the binder is selected from a group consisting of polyol, polyvinyl alcohol, ketone resin, cellulose derivatives and polyvinyl pyrrolidone.

7. The ink composition in accordance with claim 1, wherein the pH adjuster is sodium pyrophosphate.

8. The ink composition in accordance with claim 1, wherein the solvent is selected from a group consisting of water, alcohol, ketone or ester.

9. The ink composition in accordance with claim 2, wherein the moisture adjuster is glycerol, polyethylene glycol and/or propylene glycol.

10. The ink composition in accordance with claim 3, wherein the volatile reducing agent is selected from a group consisting of alcohol, ammonia, thiol, aldehyde and small molecular amine.

11. A method for manufacturing an oxygen and/or pH indicator, which method comprises the steps of mixing an oxidizing and reducing agent and/or pH colorant, polymer as the binder, pH adjuster and volatile solvent; and then
printing the ink composition onto a substrate and reducing the ink composition;
adding a volatile reducing agent to the ink composition as the redox material; reducing the dye and printing the color mixture onto a substrate.

12. The method in accordance with claim 11 wherein a moisture adjuster is mixed with the ink composition.

13. The method in accordance with claim 11, wherein the ink composition printed onto the substrate is reduced at an elevated temperature and/or with a volatile reducing agent.

14. The method as defined in claim 11, wherein the reduction is performed at a temperature of 100 to 165° C., preferably at a temperature of 120 to 130° C.

15. The method in accordance with claim 11, wherein the indicator is activated by subjecting it to conditions triggering the activation.

16. An oxygen and/or pH indicator prepared by a method in accordance with claim 11.

17. The oxygen and/or pH indicator in accordance with claim 16, wherein the substrate refers to packaging material.

18. The oxygen and/or pH indicator in accordance with claim 16, wherein the substrate is a separate base that is attached to the package.

19. The oxygen and/or pH indicator in accordance with wherein the indicator is provided with a removable and/or protecting film.

20. The oxygen and/or pH indicator in accordance with claim 16, wherein it indicates a leakage, a change in oxygen content and/or deterioration of a product by a change in color.

21. A package for stating a leakage, a change caused by oxygen content and/or deterioration of a product, characterized in that the package is formed by attaching an indicator in accordance with claim 16 to the package at the moment of packaging.

22. The package as defined in claim 21, wherein the package is a foodstuff, pharmaceutical or cosmetics package.
